(19) United States
(12) Patent Application Publication
(10) Pub. No.: US 2024/0371623 A1
(43) Pub. Date: Nov. 7, 2024

(54) ADVECTION-BASED TRANSPORT OF ABLATED MATERIAL

(71) Applicant: AGILENT TECHNOLOGIES, INC., Santa Clara, CA (US)

(72) Inventors: Trygve RISTROPH, Santa Clara, CA (US); James Alexander APFFEL, JR., Santa Clara, CA (US)

(73) Assignee: AGILENT TECHNOLOGIES, INC., Santa Clara, CA (US)

(21) Appl. No.: 18/650,576

(22) Filed: Apr. 30, 2024

Related U.S. Application Data
(60) Provisional application No. 63/499,677, filed on May 2, 2023.

(51) Int. Cl. H01J 49/04; H01J 49/16; H01J 49/24

(52) U.S. Cl. CPC H01J 49/0463; H01J 49/165; H01J 49/24

(57) ABSTRACT

In some examples, an apparatus may include an advection flow structure including a passage to transport, via advection by a gas flow, an ablated sample from an ablation region to an ionization region.

### RELATED APPLICATION

This application claims priority to co-pending U.S. Provisional Patent Application Ser. No. 63/499,677, filed May 2, 2023, titled “ADVECTION-BASED TRANSPORT OF ABLATED MATERIAL”, the disclosure of which is hereby incorporated by reference in its entirety.

### BACKGROUND

In techniques such as matrix-assisted laser desorption electrospray ionization (MALDESI) mass spectrometry, laser ablation may be utilized for chemical analysis and imaging. In one example, MALDESI is based on the intersection of analyte particles ejected from a sample in a plume from an infrared (IR) laser, with a second plume of ions being generated from an electrospray emitter to generate electrospray-like ionization from laser ablated surfaces. High-energy laser pulses may be utilized to remove the material of interest from the sample. In MALDESI, the ablated material may adsorb onto droplets that originate from electrospray. The droplets may produce ions that are analyzed by mass spectrometry. Thus, detection may require the ablated material to adsorb onto electrospray droplets and that those droplets, or ions injected from them, are collected by a mass spectrometer inlet.

### BRIEF DESCRIPTION OF DRAWINGS

Features of the present disclosure are illustrated by way of example and not limited in the following figure(s), in which like numerals indicate like elements, in which:

FIG. 1 illustrates a layout of a first embodiment of an advection-based transport of ablated material apparatus including an advection flow structure including a passage to transport, via advection by a gas flow, an ablated sample from an ablation region to an ionization region, in accordance with an example of the present disclosure;

FIG. 2 illustrates a layout of a second embodiment of an advection-based transport of ablated material apparatus including an ablation enclosure at the ablation region, an ionization enclosure at the ionization region, and where the advection flow structure connects, via the passage, the ablation enclosure to the ionization enclosure, in accordance with an example of the present disclosure;

FIG. 3 illustrates a layout of a third embodiment of an advection-based transport of ablated material apparatus including a further pump that is separate from a mass spectrometer pump to evacuate the ionization enclosure, and a differential pressure sensor to control a differential pressure between the ablation enclosure and the ionization enclosure, in accordance with an example of the present disclosure;

FIG. 4 illustrates a layout of a fourth embodiment of an advection-based transport of ablated material apparatus including a gas flow controller at the ablation enclosure, in accordance with an example of the present disclosure;

FIG. 5 illustrates a layout of a fifth embodiment of an advection-based transport of ablated material apparatus including a Venturi pump to transport, by another gas flow, the ablated sample from the ablation region to the ionization region, in accordance with an example of the present disclosure;

FIG. 6 illustrates an operational principle of infrared-matrix assisted laser desorption electrospray ionization mass spectrometry (IR-MALDESI), in accordance with an example of the present disclosure;

FIG. 7 illustrates an operational configuration associated with IR-MALDESI, in accordance with an example of the present disclosure;

FIG. 8 illustrates ESI data associated with the operational configuration of FIG. 7, in accordance with an example of the present disclosure;

FIG. 9 illustrates a layout of a sixth embodiment of an advection-based transport of ablated material apparatus including orthogonal electrospray ionization (ESI), in accordance with an example of the present disclosure;

FIG. 10 illustrates an orthogonal ESI configuration, in accordance with an example of the present disclosure;

FIG. 11 illustrates ESI data associated with the orthogonal ESI configuration of FIG. 10, in accordance with an example of the present disclosure;

FIG. 12 illustrates a layout of a seventh embodiment of an advection-based transport of ablated material apparatus including a structure that directs the advection flow to collect ablated material, in accordance with an example of the present disclosure;

FIG. 13 illustrates further details of the layout of the seventh embodiment of the advection-based transport of ablated material apparatus including an outlet of an advection tube, in accordance with an example of the present disclosure;

FIG. 14 illustrates example MALDESI data for the seventh embodiment of the advection-based transport of ablated material apparatus, in accordance with an example of the present disclosure;

FIG. 15 illustrates a layout of an eighth embodiment of an advection-based transport of ablated material apparatus including a Venturi pump for advection gas that is powered by nebulizing gas, in accordance with an example of the present disclosure;

FIG. 16A illustrates further details of the Venturi pump for advection gas that is powered by nebulizing gas, in accordance with an example of the present disclosure;

FIG. 16B illustrates an enlarged view of the Venturi pump, in accordance with an example of the present disclosure;

FIG. 17A illustrates a layout of a ninth embodiment of an advection-based transport of ablated material apparatus including an extractor structure for collecting ablation plume with advection gas, in accordance with an example of the present disclosure; and

FIG. 17B illustrates further details of the layout of the ninth embodiment of the advection-based transport of ablated material apparatus including the extractor structure for collecting ablation plume with advection gas, in accordance with an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Apparatuses for advection-based transport of ablated material, and methods for advection-based transport of ablated material are disclosed herein. For the apparatuses and methods disclosed herein, a sample vapor or aerosol may be transported from an ablation region to a separate ionization region by advection (e.g., entrainment by gas flow). The width and length of the transport channel and gas flow rate may be controlled to ensure efficient and fast transport of a sample with relatively little disruption to ionization and charge collection.

With respect to advection-based transport of ablated material, as disclosed herein, in matrix-assisted laser desorption electrospray ionization (MALDESI) mass spectrometry, detection may require that the ablated material adsorb onto electrospray droplets and that those droplets, or ions injected from them, are collected by a mass spectrometer inlet. In this regard, in order to increase the probability that each of these steps occurs, close proximity of the electrospray, sample, and mass spectrometer inlet may be needed. However, optimal environmental conditions, such as temperature, gas velocity, and electric field, may not be the same for storage of a sample, transport of ablated material, ionization, and collection by an MS inlet. In this regard, proximity may require either large spatial gradients or non-optimal conditions. This compromise may negatively affect sensitivity, speed-of-analysis, or carryover. Additionally, reproducibility, safety, power consumption, ease-of-use, cost, robustness, and flexibility of the instrument may also be compromised by forcing a sample to be close to the electrospray and MS inlet.

In order to address at least the aforementioned sensitivity aspects, the ablation plume may be collimated with a tapered capillary that contains a sample. This collimation of the ablation plume with the tapered capillary may not be very effective at reducing losses to the walls since the residence time may be relatively long compared to the diffusion time. Liquid samples may be drawn into a capillary, which may limit speed, may cause carry-over, and may be inapplicable to solid samples.

In some examples, nano-desorption electrospray ionization (NanoDESI) may avoid gas-phase diffusion altogether by dissolving a sample in a liquid and then electro-spraying the solution. Speed and spatial resolution may be limited as a result. Further, applying nanoDESI to liquid samples in well-plates for high through-put analysis may include drawbacks related to carry-over and limited speed.

The apparatuses and methods disclosed herein address at least the aforementioned drawbacks and additional aspects by providing for efficient transport of abated sample material to a remote ionization region, which addresses several constraints imposed by colocation. Removing these constraints provides for improvements to sensitivity, speed, carryover, stability, and noise.

In other examples, prior to ablation, it may be preferred not to change a sample in any way. Proximity of the ESI and sample may compromise this goal. For example, ESI may require evaporation and therefore supply heat and a drying gas. When a sample and an ESI source are relatively close, the heat and drying gas may evaporate the sample prior to ablation, which may result in irreproducibility and measurement error. In this regard, the apparatuses and methods disclosed herein provide for independent optimization of a sample temperature and an ESI temperature.

In further examples, with respect to gas composition, humidity may be helpful for ablation for some samples. Further, whereas living cells need Oxygen, optimum ionization may require a different gas composition. In this regard, the apparatuses and methods disclosed herein address carry-over between samples or degradation by providing for control of a sample's environment.

Yet further, transport of ablated material to charged droplets may be inefficient or relatively slow. In some cases, diffusion or uncontrolled advection may be implemented, and sensitivity may be improved by using controlled advection. Advection may be relatively faster than diffusion for typical values of gas velocity and distances between a sample and ESI. The shorter transport time may reduce sample dilution by diffusion, which may spread the sample in all directions. By entraining the ablated sample in a controlled gas flow, the apparatuses and methods disclosed herein provide for independent optimization of the conditions for ablation, electrospray, and capture by a MS. For example, in addition to evaporating a sample prior to ablation, the drying gas flow may also direct the ablated material away from the MS inlet via counter-productive advection. In this regard, the apparatuses and methods disclosed herein provide for independent selection of the gas velocities for collecting the ablated material and the drying gas.

In other examples, transport of charged particles (e.g., charged droplets or ions) to an MS inlet may rely on an electric field. The presence of a sample and its holder may change that electric field so that the charge is no longer pulled into the MS efficiently. The apparatuses and methods disclosed herein may provide for independent optimization and control of the electrical field regardless of sample properties. Separation may prevent ESI from charging insulating samples. Additionally, the sample flow may be introduced into the electrospray plume at a location where absorption, ionization, and collection are probable. The ability to choose where the ablated sample is introduced in the electrospray may be particularly important when considering the effect of the advective flow on the electrospray itself and the optimum droplet size for absorption.

The improvements to sensitivity that are discussed above may also provide benefits related to stability or reproducibility. Gas velocity, temperature, and electric field may slowly change due to multiple different mechanisms. A sample may redirect gas, absorb heat, evaporate, and charge if insulating. Additionally, these instabilities may depend on the sample holder, liquid level, surface roughness, solvent, and any matrix. These dependencies may negatively affect reproducibility when analyzing diverse samples. Separating sample and ESI regions may facilitate stabilization of the critical parameters.

Many of the mechanisms of sample loss may also fluctuate on even shorter time scales, comparable to measurement duration, and therefore cause measurement noise. In this regard, the apparatuses and methods disclosed herein provide improvement in measurement noise by stabilizing the rapidly fluctuating parameter. An example of a relatively rapidly fluctuating parameter is gas velocity in turbulent flow. The gas velocity field used for advection may be laminar and in steady-state while the gas velocity in the ESI region may be turbulent.

The apparatuses and methods disclosed herein provide for improvement in speed and carry-over, in that the apparatuses and methods disclosed herein may use controlled advection rather than diffusion or uncontrolled advection. Relying on diffusion may slow down the rate at which measurements are made. Diffusion may mix material from different samples to thus cause carry-over, which can also be negatively affected by uncontrolled gas flow, for example eddies that recirculate ablated material.

The apparatuses and methods disclosed herein further provide improvements with respect to sensitivity, speed, carry-over, measurement error, robustness, or ease-of-use. Additionally, the apparatuses and methods disclosed herein simplify the addition of MALDESI to an ESI instrument with minimal modifications to the ESI source.

Although the aforementioned discussion with respect to the apparatuses and methods disclosed herein specifies MALESI-MS, the concepts may apply to any instrument using ablation and chemical analysis.

According to another aspect of the apparatuses and methods disclosed herein, in some cases, an electrospray emitter may be pointed directly at the inlet of a mass spectrometer. In some cases, there is an opposing drying gas flow. This geometry may be harmful in that large un-desolvated droplets from the ESI emitter may enter the mass spectrometer inlet and lead to increased noise and signal instability. Further, the opposing drying gas flow may blow away desolvating droplets or ions before they interact with laser ablated analytes, thus decreasing sensitivity.

In order to address at least the aforementioned disadvantages with respect to operation of the electrospray emitter that is pointed directly at the inlet of the mass spectrometer, by moving the ESI emitter 90° so that it is spraying orthogonally to the inlet of the MS, the ESI plume may still interact with the laser ablated plume producing the resulting charged particles which can be drawn into the MS inlet electrostatically. In this regard, the ESI emitter may be moved in the range of 30° to 170°, and positioned preferably at 90°. Any drying gas that exits from the MS inlet may be used to dry the ESI droplets without disturbing the formation of the original ESI Plume. Voltages may be applied to both the ESI emitter and the MS inlet to sculpt the fields and manipulate both the ESI ions and the resulting sample ions.

The apparatuses and methods disclosed herein further provide for the heating and drying to be decoupled from the electrospray ionization process. The apparatuses and methods disclosed herein provide for the generation of electrospray ions for the IR-MALDESI process with reduced noise and higher ionization efficiency, while decoupling desolvation processes from the electrospray ion production process.

According to examples disclosed herein, an apparatus may include an advection flow structure including a passage to transport, via advection by a gas flow, an ablated sample from an ablation region to an ionization region.

For the apparatus described above, the advection flow structure may include a tube that includes the passage.

For the apparatus described above, a length of the passage may be sized to reduce losses due to diffusion of the ablated sample to a wall of the advection flow structure.

The apparatus described above may include an ablation enclosure at the ablation region, and an ionization enclosure at the ionization region. The advection flow structure may connect, via the passage, the ablation enclosure to the ionization enclosure.

For the apparatus described above, the ablation enclosure may include an ablation enclosure pressure that is greater than an ionization enclosure pressure of the ionization enclosure.

The apparatus described above may further include a pressure generator operatively connected to the ablation enclosure to generate an ablation enclosure pressure that is greater than an ionization enclosure pressure of the ionization enclosure.

The apparatus described above may further include a mass spectrometer connected to the ionization enclosure. The mass spectrometer may include a mass spectrometer pump to evacuate the ionization enclosure.

The apparatus described above may further include a further pump that is separate from the mass spectrometer pump to evacuate the ionization enclosure. A differential pressure sensor may control a differential pressure between the ablation enclosure and the ionization enclosure.

The apparatus described above may further include a Venturi pump to transport, by another gas flow, the ablated sample from the ablation region to the ionization region.

The apparatus described above may further include an electrospray ionization (ESI) emitter to emit ions to intersect analyte particles ejected from the advection flow structure. A mass spectrometer (MS) including a MS inlet may receive the ions subjected to electrospray-like ionization by the ESI emitter. The MS inlet may be orthogonally positioned relative to the ESI emitter.

According to examples disclosed herein, an apparatus may include an ablation enclosure at an ablation region, and/or an ionization enclosure at an ionization region. An advection flow structure may include a passage to transport, via advection, an ablated sample from the ablation region to the ionization region.

According to examples disclosed herein, a method may include utilizing advection to transport, through a passage of an advection flow structure, an ablated sample from an ablation region to an ionization region.

For the method described above, the ablation region may include an ablation enclosure, and the ionization region may include an ionization enclosure. The method may further include transporting, through the passage, the ablated sample from the ablation enclosure to the ionization enclosure.

The method described above may further include maintaining the ablation enclosure at an ablation enclosure pressure that is greater than an ionization enclosure pressure of the ionization enclosure.

The method described above may further include generating, by a pressure generator that is operatively connected to the ablation enclosure, an ablation enclosure pressure that is greater than an ionization enclosure pressure of the ionization enclosure.

The method described above may further include receiving, by a mass spectrometer (MS) inlet of a MS, ions from the ionization enclosure that are subjected to electrospray-like ionization.

The method described above may further include evacuating, by a MS pump of the MS, the ionization enclosure.

The method described above may further include evacuating, by a further pump that is separate from the MS pump, the ionization enclosure.

The method described above may further include utilizing an electrospray ionization (ESI) emitter to emit ions to intersect analyte particles ejected from the advection flow structure, and receiving, by a mass spectrometer (MS) inlet of a MS, the ions subjected to electrospray-like ionization by the ESI emitter. The MS inlet may be orthogonally positioned relative to the ESI emitter.

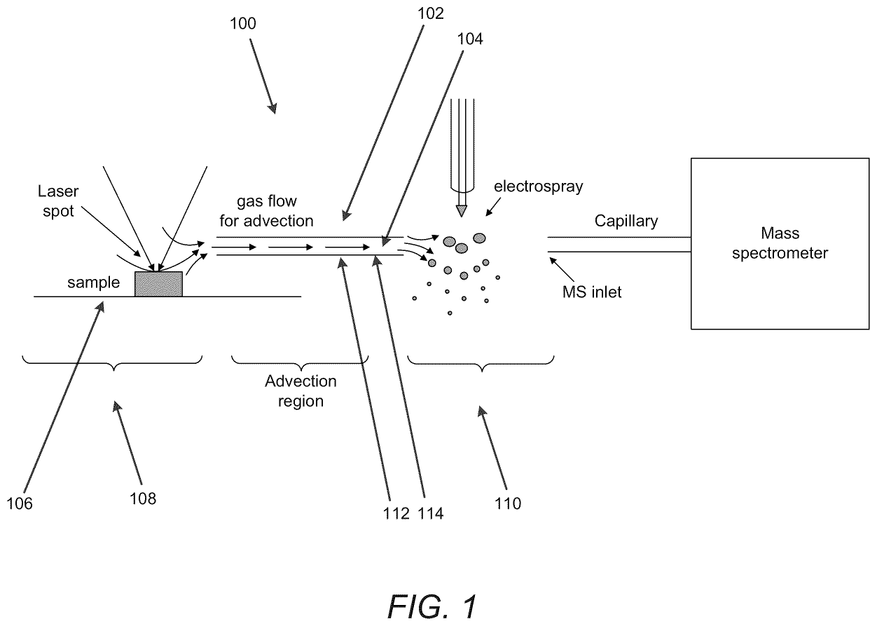

FIG. 1 illustrates a layout of a first embodiment of an advection-based transport of ablated material apparatus including an advection flow structure including a passage to transport, via advection by a gas flow, an ablated sample from an ablation region to an ionization region (hereinafter also referred to as “apparatus 100”), in accordance with an example of the present disclosure.

Referring to FIG. 1, the apparatus 100 may include an advection flow structure 102 including a passage 104 to transport, via advection by a gas flow, an ablated sample 106 from an ablation region 108 to an ionization region 110. The advection flow structure may include a tube 112 that includes the passage 104. According to examples disclosed herein, a length of the passage 104 may be sized to reduce losses due to diffusion of the ablated sample to a wall 114 of the advection flow structure.

With continued reference to FIG. 1, the ablated sample 106 may be transported via advection (e.g., entrainment) by a controlled gas flow. The gas flow and geometry of the advection flow structure 102 may be selected to minimize losses from diffusion and turbulence.

The flow rate \dot{V} and tube length l of the tube 112 may be selected to reduce losses due to diffusion to the walls. In some cases, samples of interest are non-volatile and may adhere to the walls of the tube 112 upon contact. Losses may be relatively small if the distance over which material diffuses during the time it spends in the tube (e.g., residence time) is small relative to the tube diameter.

The ratio of the diffusional time to residence time may be given by

$$\frac{{t}_{d}}{{t}_{r}} = \frac{\dot{V}}{2 π Dl} ,$$

where D is the diffusion constant. Using a plug-flow approximation for the flow, a characteristic flow in the tube 112 may be defined by \dot{V}_{c}=2πDl. When the flow is several times larger than \dot{V}_{c}, diffusive losses may be reduced. Further increases in the flow beyond \dot{V}_{c} may have minimal benefit, and may be detrimental if the flow becomes turbulent. A flow several times \dot{V}_{c} may be preferred because diffusive losses may be reduced while avoiding turbulent flow, impractically large pressure differences, and disruption of the ESI region.

The aforementioned principles may also apply to embodiments that do not use a tube. In such embodiments, the losses may be into free space as opposed to the walls of the tube 112.

The use of the tube 112 may be advantageous with respect to control of gas flow, isolation of regions, robustness to external perturbations, and prevention of carry-over due to circulation of gas.

Examples values for parameters that may be utilized for a MALDESI instrument may include the tube 112 including a length l=40 mm and inner diameter d=6 mm. The particles may include a diffusion constant D=0.2 cm²/s, which is typical of a small molecule in air at normal temperature and pressure. However, large molecules and aerosol droplets may include lower diffusion constants. The characteristic flow may be specified as \dot{V}_{c}=5 cm³/s. The pressure drop across the tube may be roughly estimated from Poiseuille flow to be 0.12 Pa. The actual pressure drop may be larger, because the flow is undeveloped and may be operated at several times V.

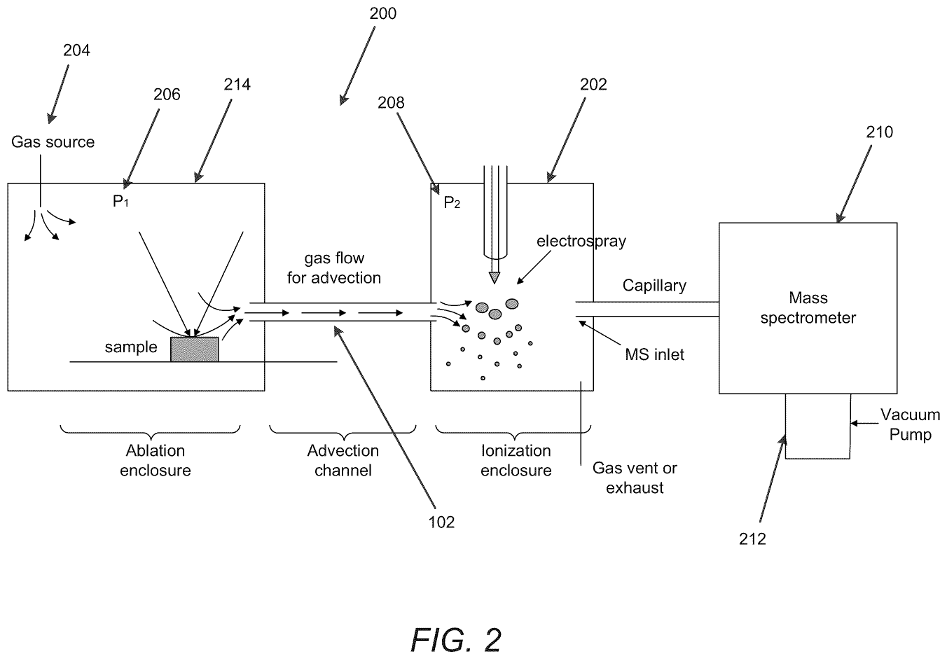

The flow may be generated in several ways. For example, a first technique may include generating and controlling a pressure difference between two enclosures (e.g., as disclosed herein with respect to FIG. 2). When the pressure in the ablation region (108; P₁) is larger than the pressure in the ionization region (110; P₂), gas will flow from the ablation region 108 to the ionization region 110. A preferred value of the pressure difference may be found empirically, by calculation, or calibration of the tube's conductance. Control of the pressure difference may be implemented with various control schemes such as mechanical regulators and electronic control systems.

FIG. 2 illustrates a layout of a second embodiment of an advection-based transport of ablated material apparatus including an ablation enclosure at the ablation region, an ionization enclosure at the ionization region, and where the advection flow structure connects, via the passage, the ablation enclosure to the ionization enclosure (hereinafter also referred to as “apparatus 200”), in accordance with an example of the present disclosure.

Referring to FIG. 2, the apparatus 200 may include an ablation enclosure 214 at the ablation region, and an ionization enclosure 202 at the ionization region. The advection flow structure 102 may connect, via the passage 104, the ablation enclosure 214 to the ionization enclosure 202. According to examples disclosed herein, the ablation enclosure 214 may include an ablation enclosure pressure 206 (e.g., P₁) that is greater than an ionization enclosure pressure 208 (e.g., P₂) of the ionization enclosure 202. A pressure generator 204 (e.g., gas source) may be operatively connected to the ablation enclosure 214 to generate an ablation enclosure pressure 206 that is greater than an ionization enclosure pressure 208 of the ionization enclosure 202. A mass spectrometer 210 may be connected to the ionization enclosure 202. According to examples disclosed herein, the mass spectrometer 210 may include a mass spectrometer pump 212 to evacuate the ionization enclosure 202.

With continued reference to FIG. 2, the pressure difference (P₁ vs. P₂) may be generated by pressurizing the ablation enclosure 214, pumping the ionization enclosure 202, or both. The pressurizing gas may have controlled composition (e.g., humidity, Oxygen, CO₂ concentration, etc.) and temperature. Excess pressurizing gas may be vented. Evacuation of the ionization enclosure 202 may use the mass spectrometer's pumps (e.g., 212) or a separate pump. In some cases, the total gas flow for ESI (e.g., nebulizing gas, drying gas, solvent vapor, etc.) may exceed the flow of gas flowing into the MS inlet and a separate pump may be needed.

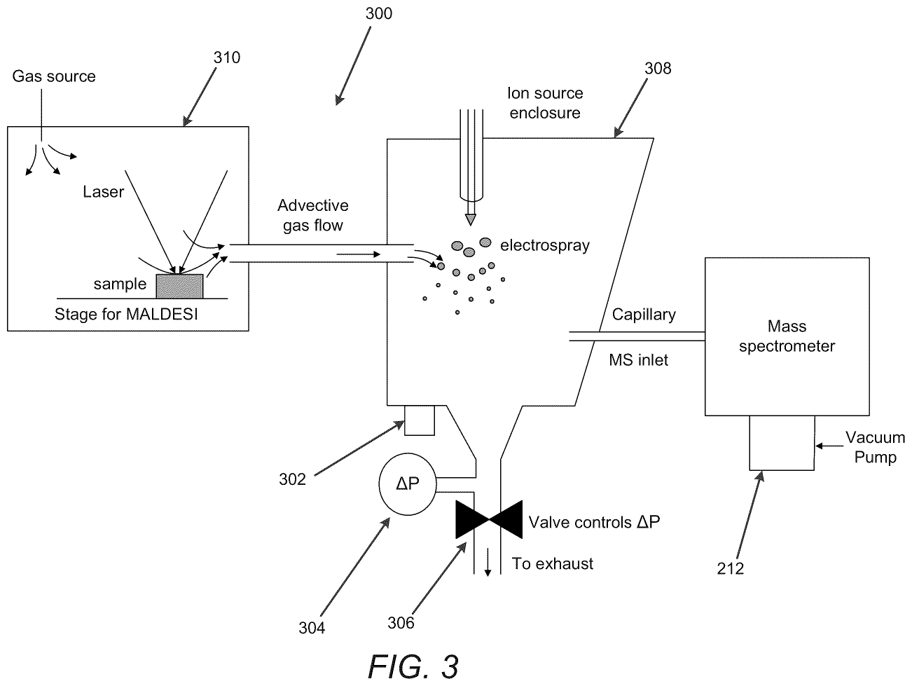

FIG. 3 illustrates a layout of a third embodiment of an advection-based transport of ablated material apparatus including a further pump that is separate from a mass spectrometer pump to evacuate the ionization enclosure, and a differential pressure sensor to control a differential pressure between the ablation enclosure and the ionization enclosure (hereinafter also referred to as “apparatus 300”), in accordance with an example of the present disclosure.

Referring to FIG. 3, a further pump 302 that is separate from the mass spectrometer pump 212 may evacuate ionization enclosure 308. A differential pressure sensor 304 may control a differential pressure between the ablation enclosure 310 and the ionization enclosure 308.

With continued reference to FIG. 3, in some examples disclosed herein, the ionization enclosure 308 may be pumped by both the MS inlet and an additional pump 302. This case may apply when adding MALDESI to an existing ESI instrument. In some cases, gas from an ESI source including solvent vapor may be pumped by an exhaust. This embodiment may use a differential pressure sensor 304, continuously variable valve 306, and a control system (not shown) to control the differential pressure between the ablation enclosure 310 and the ionization enclosure 308. By stabilizing the differential pressure, the advective flow may also be stabilized. For the example of FIG. 3, the flow may be non-linear in pressure difference. In other examples, the ablation enclosure 310 may be pressurized slightly above atmosphere with a gas of controlled composition.

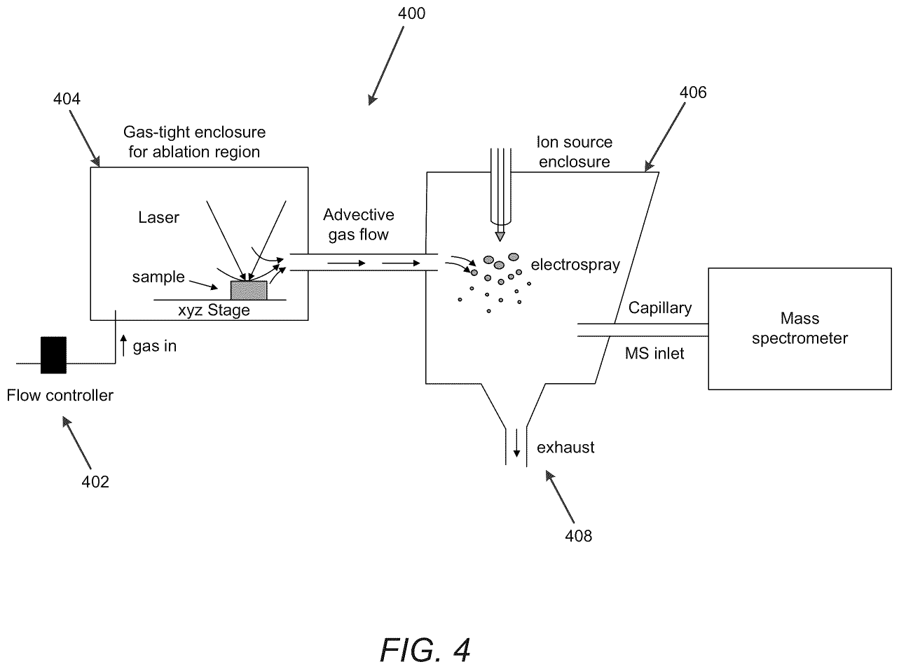

FIG. 4 illustrates a layout of a fourth embodiment of an advection-based transport of ablated material apparatus including a gas flow controller at the ablation enclosure (hereinafter also referred to as “apparatus 400”), in accordance with an example of the present disclosure.

Referring to FIG. 4, compared to the example of FIG. 3, for the apparatus 400, a gas flow controller 402 may be provided at ablation enclosure 404. Additionally, ionization enclosure 406 may include an exhaust port 408. The gas flow controller 402 and the exhaust port 408 may provide for maintenance of a specified pressure differential between the ablation enclosure 404 and the ionization enclosure 406.

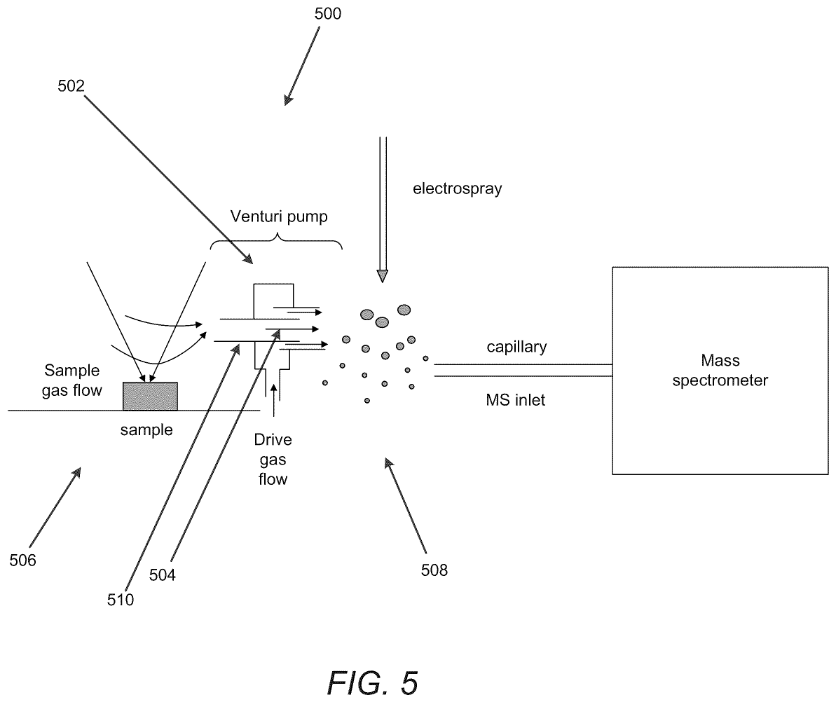

FIG. 5 illustrates a layout of a fifth embodiment of an advection-based transport of ablated material apparatus including a Venturi pump to transport, by another gas flow, the ablated sample from the ablation region to the ionization region (hereinafter also referred to as “apparatus 500”), in accordance with an example of the present disclosure.

Referring to FIG. 5, a Venturi pump 502 may be utilized to transport, by another gas flow, ablated sample 504 from the ablation region 506 to the ionization region 508. In this regard, in some cases, enclosing the two regions may not be practical and the flow may be generated by a Venturi pump 502, fans, or jets. Venturi pumps may accelerate gas for advection by introducing a second gas flow (e.g., a drive gas) that is at high velocity in the direction of advection. As the drive flow deaccelerates, the drive flow may entrain gas to create the advective flow. An approximate value for the maximum pressure difference that can be created may be specified by the Bernoulli's equation. In order to minimize dilution, the area of the jet may be relatively smaller compared to a cross-sectional area of tube 510.

Instead of the Venturi pump 502, other means may be utilized to generate the advective flow in an open environment. In a similar manner as the Venturi pump 502, other high-speed flows may entrain a secondary flow for advection of a sample. For example, a counter-flow drying gas that is co-axial with the MS inlet may entrain a secondary flow. Similarly, the electrospray ionization (ESI) itself may entrain gas in its wake. This wake may be generated by a nebulizing gas or by the acceleration of gas by the charged droplets. Fans may also be used to generate flow in an open environment. Other techniques of actuating flow may include acoustic streaming and natural convection.

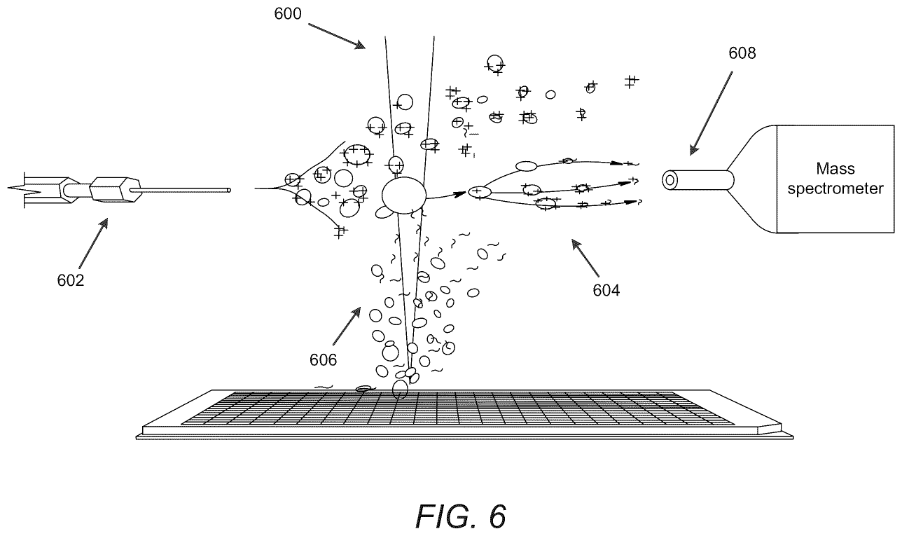

FIG. 6 illustrates an operational principle of infrared-matrix assisted laser desorption electrospray ionization mass spectrometry (IR-MALDESI), in accordance with an example of the present disclosure.

Referring to FIG. 6, IR-MALDESI is based on the intersection of analyte particles ejected from a sample in a plume 606 from an IR laser 600 with a second plume of ions generated from an electrospray emitter 602 to generate electrospray-like ionization 604 from laser ablated surfaces. The resulting charged particles may be drawn into MS inlet 608 electrostatically.

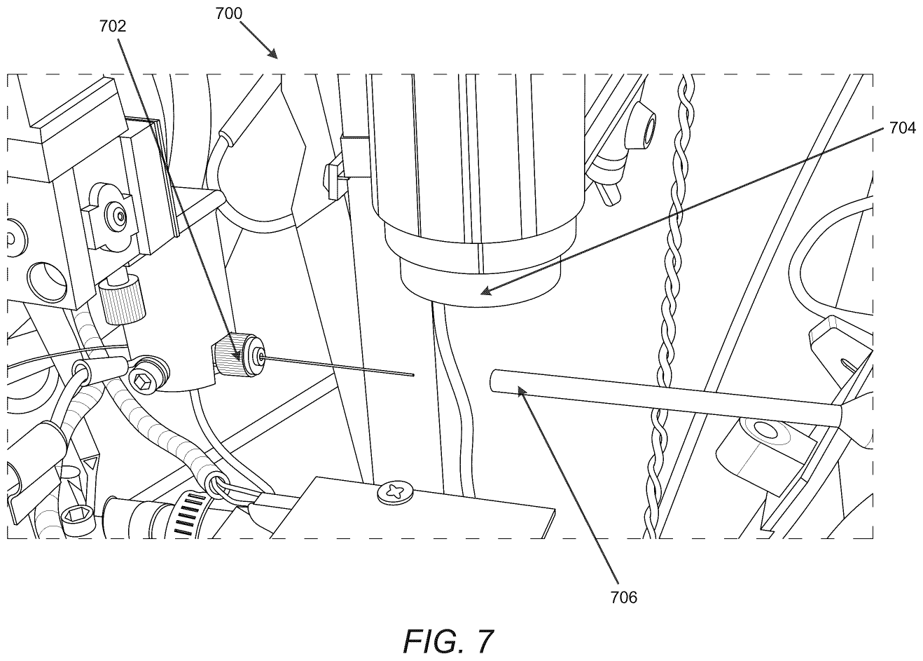

FIG. 7 illustrates an operational configuration associated with IR-MALDESI, in accordance with an example of the present disclosure.

Referring to FIG. 7, the operational configuration for system 700 shows the orientation of electrospray emitter 702, laser 704, and MS inlet 706. In the example of FIG. 7, system 700 may be operated in an electrospray ionization (ESI) mode, with an ESI liquid flow of 1.5 ul/min. The ESI liquid may contain compounds that generate tracking ions at m/z 121 and m/z 922 to monitor the ESI intensity and stability.

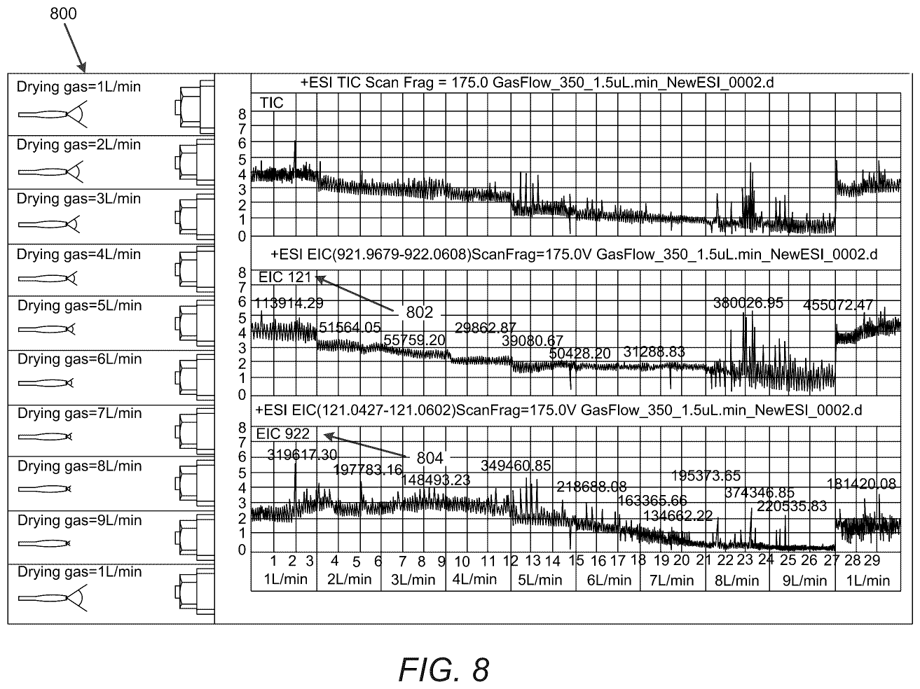

FIG. 8 illustrates ESI data associated with the operational configuration of FIG. 7, in accordance with an example of the present disclosure.

Referring to FIG. 8, as the drying gas flow exiting the MS inlet increases from 1 L/min to 9 L/min, the electrospray plume as shown by the images at 800 and the ESI signal as shown by the EIC m/z 121 at 802 and m/z 922 at 804, become increasingly noisy while decreasing in signal intensity.

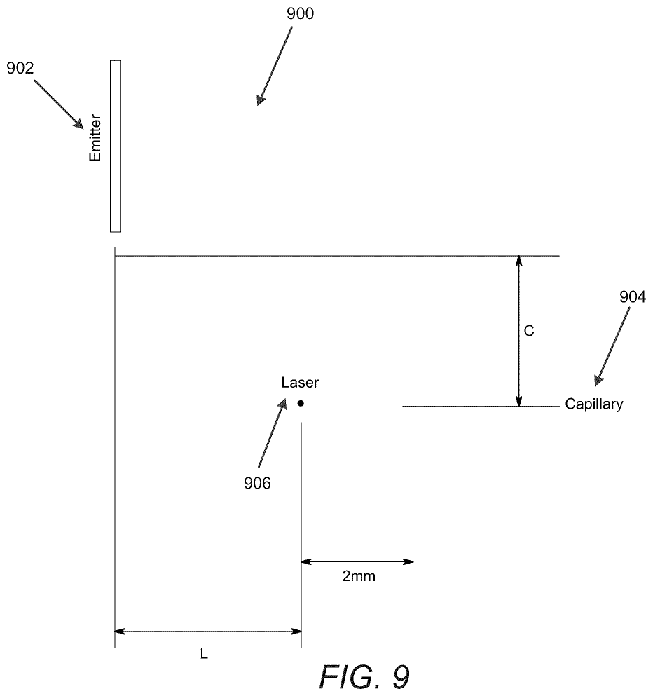

FIG. 9 illustrates a layout of a sixth embodiment of an advection-based transport of ablated material apparatus including orthogonal ESI (hereinafter also referred to as “apparatus 900”), in accordance with an example of the present disclosure.

Referring to FIG. 9, an example orientation of an ESI emitter 902, an MS inlet 904, and a laser 906 are shown. As shown, the ESI emitter 902 may be positioned at 90° relative to the MS inlet 904 so that the ESI emitter 902 is spraying orthogonally relative to the MS inlet 904. In this regard, the ESI emitter 902 may be positioned in the range of 30° to 170°, and preferably at 90°, relative to the MS inlet 904. For this orientation of the ESI emitter 902 and the MS inlet 904, the ESI plume may interact with the laser ablated plume, thus producing the resulting charged particles that may be drawn into the MS inlet 904 electrostatically. The orthogonal orientation of the ESI emitter 902 relative to the MS inlet 904 may be implemented in conjunction with or independently from MALDESI as disclosed herein.

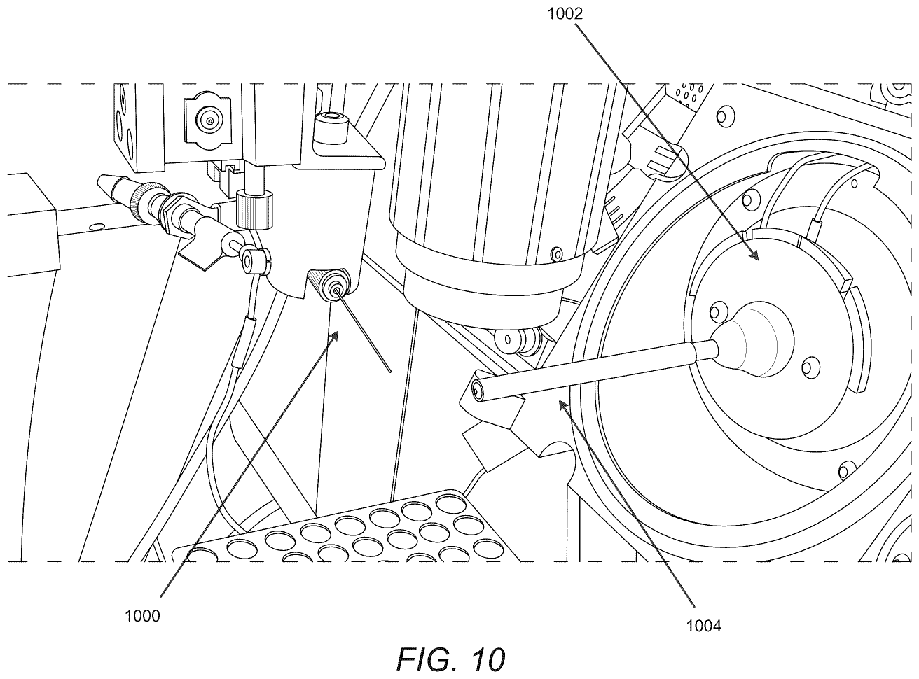

FIG. 10 illustrates an orthogonal ESI configuration, in accordance with an example of the present disclosure.

Referring to FIG. 10, an ESI emitter 1000 may emit ions to intersect analyte particles ejected from the advection flow structure. An MS 1002 including MS inlet 1004 may receive the ions subjected to electrospray-like ionization by the ESI emitter 1000. The MS inlet 1004 may be orthogonally positioned relative to the ESI emitter 1000.

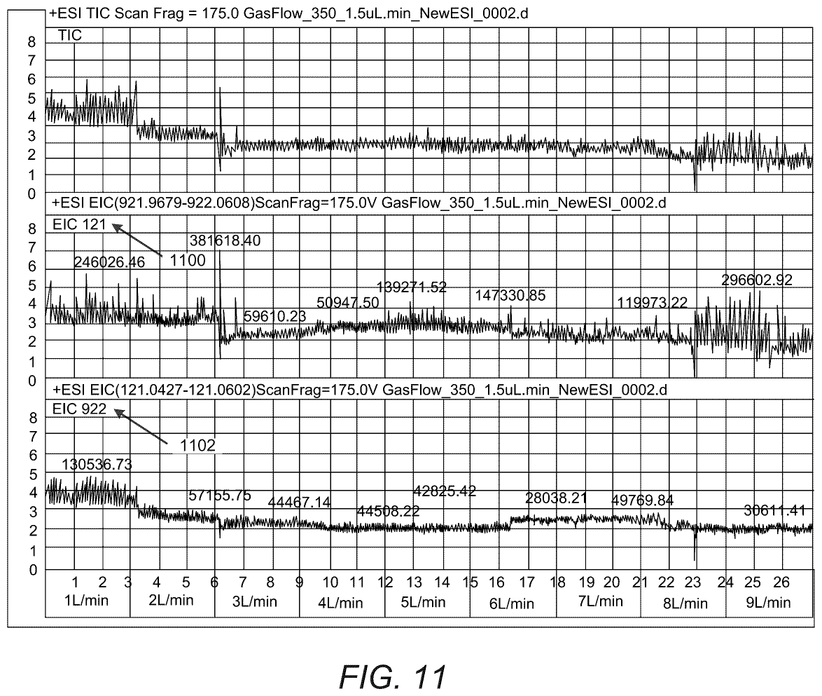

FIG. 11 illustrates ESI data associated with the orthogonal ESI configuration of FIG. 10, in accordance with an example of the present disclosure.

Referring to FIG. 11, as the drying gas flow exiting the MS inlet increases from 1 L/min to 9 L/min, the ESI signal as shown by the EIC m/z 121 at 1100 and m/z 922 at 1102 remain relatively stable (compared to the example of FIG. 8). Thus, compared to the example of FIG. 8, both the stability and signal intensity are less dependent on gas flow as shown.

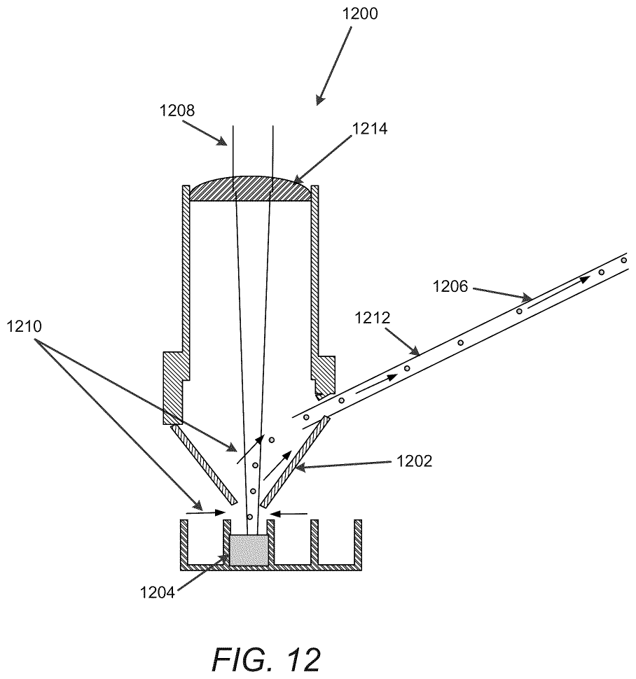

FIG. 12 illustrates a layout of a seventh embodiment of an advection-based transport of ablated material apparatus (hereinafter also referred to as “apparatus 1200”) including a structure that directs the advection flow to collect ablated material, in accordance with an example of the present disclosure.

Referring to FIG. 12, the apparatus 1200 may include a structure 1202 that is disposed above sample 1204, which may include a liquid sample. The structure 1202 may direct advection flow 1206 as shown. The structure 1202 facilitates collection of the ablated material by guiding the advection flow (e.g., via advection gas flow) as shown at 1210 into advection tube 1212. In the example of FIG. 12, the apparatus 1200 may include a lens 1214 including a focal length of 75 mm, which may vary between 25 to 150 mm.

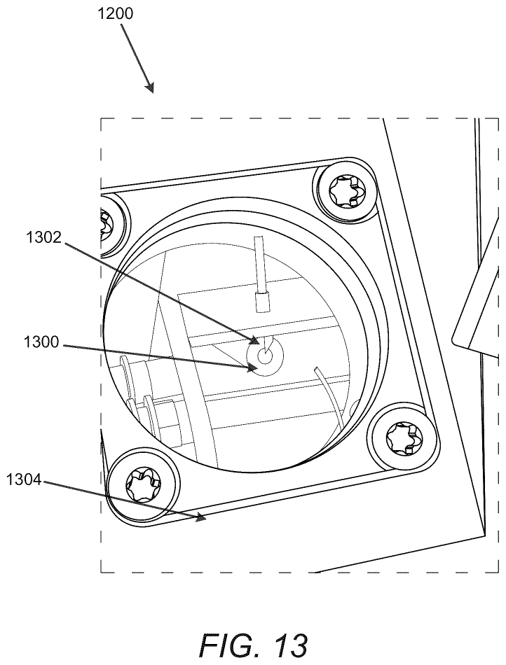

FIG. 13 illustrates further details of the layout of the apparatus 1200, including an outlet of the advection tube, in accordance with an example of the present disclosure.

Referring to FIG. 13, for the apparatus 1200, the advection tube 1212 may include an outlet 1300. The apparatus 1200 may further include an electrospray needle 1302 and an ionization chamber 1304.

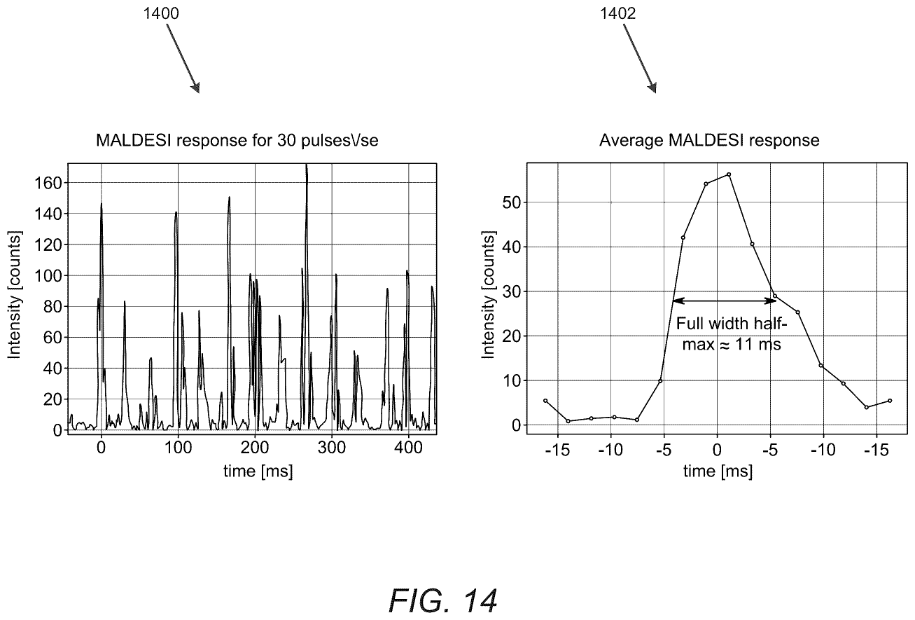

FIG. 14 illustrates example MALDESI data for the apparatus 1200, in accordance with an example of the present disclosure.

Referring to FIG. 14, for the apparatus 1200, MALDESI response for 30 pulses/sec is shown at 1400, and average MALDESI response is shown at 1402.

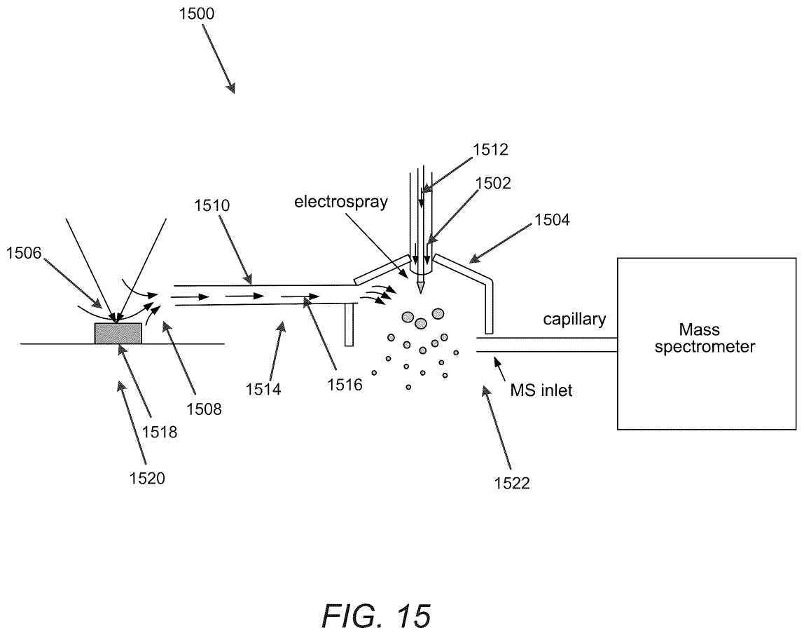

FIG. 15 illustrates a layout of an eighth embodiment of an advection-based transport of ablated material apparatus (hereinafter also referred to as “apparatus 1500”), in accordance with an example of the present disclosure.

Referring to FIG. 15, the apparatus 1500 may include utilization of ESI nebulizing gas 1502 as the drive gas for a Venturi pump 1504. In this regard, the Venturi pump 1504 may be utilized for advection gas that is powered by the nebulizing gas 1502. The apparatus 1500 may include a laser beam 1506 to facilitate collection of ablated material by guiding advection flow (e.g., via advection gas flow) as shown at 1508 into advection tube 1510. The Venturi pump 1504 may be utilized for advection gas that is powered by the nebulizing gas 1502, and mix with ESI liquid flow 1512. Thus, the advection flow structure 1514 may include a passage 1516 to transport, via advection by a gas flow, an ablated sample 1518 from an ablation region 1520 to an ionization region 1522.

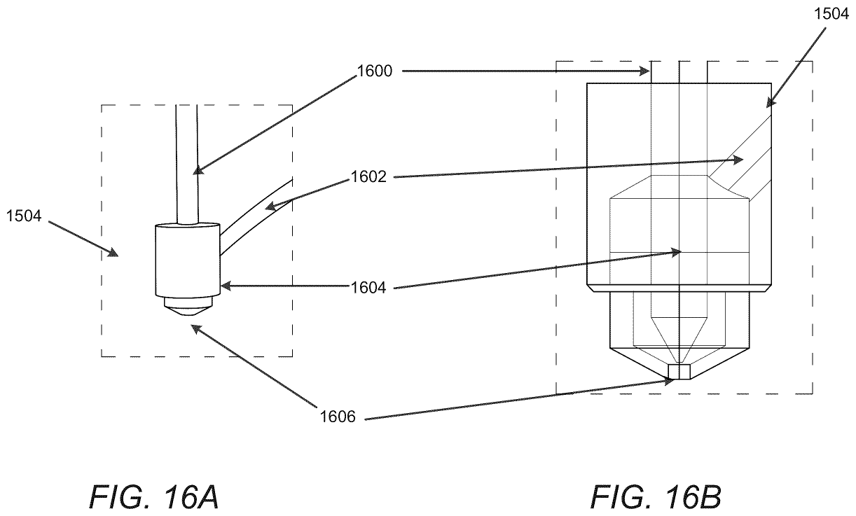

FIG. 16A illustrates further details of the Venturi pump for advection gas that is powered by nebulizing gas, in accordance with an example of the present disclosure. FIG. 16B illustrates an enlarged view of the Venturi pump, in accordance with an example of the present disclosure.

Referring to FIGS. 16A and 16B, the Venturi pump 1504 may include a tip 1600 with nebulizing gas and the liquid sample. Tube 1602 may be utilized for advection gas. A housing 1604 may be utilized to pull in the advection gas. Further, the Venturi pump 1504 may include an outlet 1606 with electrospray and advection gas.

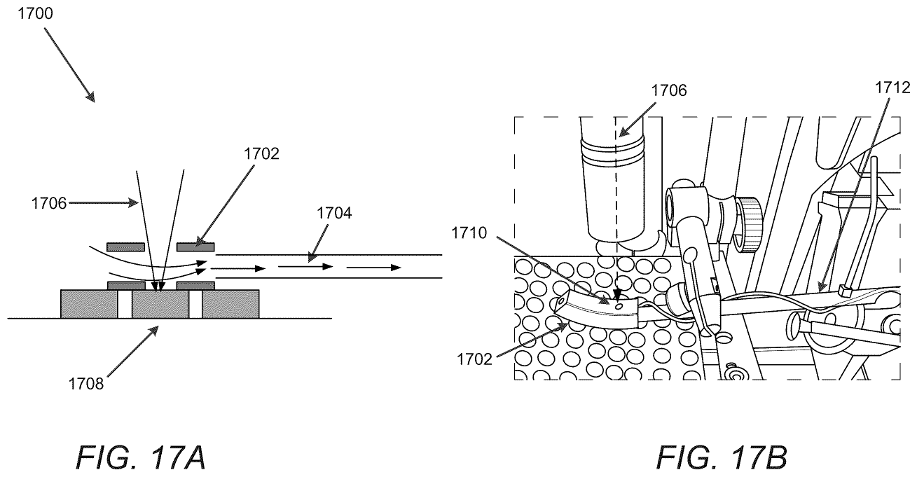

FIG. 17A illustrates a layout of a ninth embodiment of an advection-based transport of ablated material apparatus (hereinafter also referred to as “apparatus 1700”) including an extractor structure for collecting ablation plume with advection gas, in accordance with an example of the present disclosure. FIG. 17B illustrates further details of the layout of the apparatus 1700″, in accordance with an example of the present disclosure.

Referring to FIG. 17A, the apparatus 1700 may include an extractor 1702 for collecting ablation plume with advection gas. In this regard, the extractor 1702 may direct gas flow near the ablation plume. The advection gas flow may be directed as shown at 1704. The laser path and the sample are shown respectively at 1706 and 1708.

Referring to FIG. 17B, the apparatus 1700 may include a hole for the laser at 1710. The advection gas flow may be directed through advection tube 1712.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An apparatus comprising:
an advection flow structure including a passage to transport, via advection by a gas flow, an ablated sample from an ablation region to an ionization region.

2. The apparatus according to claim 1, wherein the advection flow structure includes a tube that includes the passage.

3. The apparatus according to claim 1, wherein a length of the passage is sized to reduce losses due to diffusion of the ablated sample to a wall of the advection flow structure.

4. The apparatus according to claim 1, further comprising:
an ablation enclosure at the ablation region; and
an ionization enclosure at the ionization region,
wherein the advection flow structure connects, via the passage, the ablation enclosure to the ionization enclosure.

5. The apparatus according to claim 4, wherein the ablation enclosure includes an ablation enclosure pressure that is greater than an ionization enclosure pressure of the ionization enclosure.

6. The apparatus according to claim 4, further comprising:
a pressure generator operatively connected to the ablation enclosure to generate an ablation enclosure pressure that is greater than an ionization enclosure pressure of the ionization enclosure.

7. The apparatus according to claim 4, further comprising:
a mass spectrometer connected to the ionization enclosure.

8. The apparatus according to claim 7, wherein the mass spectrometer includes a mass spectrometer pump to evacuate the ionization enclosure.

9. The apparatus according to claim 8, further comprising:
a further pump that is separate from the mass spectrometer pump to evacuate the ionization enclosure; and
a differential pressure sensor to control a differential pressure between the ablation enclosure and the ionization enclosure.

10. The apparatus according to claim 1, further comprising:
a Venturi pump to transport, by another gas flow, the ablated sample from the ablation region to the ionization region.

11. The apparatus according to claim 1, further comprising:
a Venturi pump to transport, by electrospray ionization (ESI) nebulizing gas, the ablated sample from the ablation region to the ionization region.

12. The apparatus according to claim 1, further comprising:
an extractor structure to collect an ablation plume associated with the ablated sample with advection gas.

13. The apparatus according to claim 1, further comprising:
an electrospray ionization (ESI) emitter to emit ions to intersect analyte particles ejected from the advection flow structure; and
a mass spectrometer (MS) including a MS inlet to receive the ions subjected to electrospray-like ionization by the ESI emitter,
wherein the MS inlet is orthogonally positioned relative to the ESI emitter.

14. An apparatus comprising:
at least one of
an ablation enclosure at an ablation region, or
an ionization enclosure at an ionization region; and
an advection flow structure including a passage to transport, via advection, an ablated sample from the ablation region to the ionization region.

15. A method comprising:
utilizing advection to transport, through a passage of an advection flow structure, an ablated sample from an ablation region to an ionization region.

16. The method according to claim 15, wherein the ablation region includes an ablation enclosure, and the ionization region includes an ionization enclosure, further comprising:
transporting, through the passage, the ablated sample from the ablation enclosure to the ionization enclosure.

17. The method according to claim 16, further comprising:
maintaining the ablation enclosure at an ablation enclosure pressure that is greater than an ionization enclosure pressure of the ionization enclosure.

18. The method according to claim 16, further comprising:
receiving, by a mass spectrometer (MS) inlet of a MS, ions from the ionization enclosure that are subjected to electrospray-like ionization.

19. The method according to claim 18, further comprising:
evacuating, by a MS pump of the MS, the ionization enclosure.

20. The method according to claim 19, further comprising:
evacuating, by a further pump that is separate from the MS pump, the ionization enclosure.
